(19) United States
(12) Patent Application Publication
(10) Pub. No.: US 2006/0017965 A1
(43) Pub. Date: Jan. 26, 2006

(54) Image forming apparatus, image forming method, computer program, and computer-readable storage medium

(75) Inventor: Nobuyuki Tonegawa, Kawasaki-Shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/182,786

(22) Filed: Jul. 18, 2005

(30) Foreign Application Priority Data
Jul. 20, 2004 (JP) 2004-211962

(51) Int. Cl. G06F 15/00

(52) U.S. Cl. 358/1.15

(57) ABSTRACT

Provided is an image communication apparatus which describes the mail addresses of all recipients in electronic mail address fields To, Cc, and Bcc, thereby allowing each recipient to check to whom the mail has been transmitted, and which can add the transmission date and time, sender information, recipient information, and the page number information to the header portion of a scanned image. The image communication apparatus of this invention includes an image reading unit for optically reading an image and converting the read image into electronic data, a transmission address input unit capable of designating a plurality of destinations, an address field forming unit for forming an electronic mail address field describing all the addresses designated by the destination input unit, an image header adding unit for adding address information of at least one address to the image read by the image reading unit, an image converting unit for compressing the synthesized image, an electronic mail data forming unit for forming electronic mail data on the basis of the electronic mail address field and the compressed image obtained by the image converting unit, and a transmitting unit for transmitting the electronic mail data formed by the electronic mail data forming unit to each destination.

### FIELD OF THE INVENTION

The present invention relates to a communication apparatus having a transmitter which transmits an image read by a scanner or the like by attaching the image to electronic mail.

### BACKGROUND OF THE INVENTION

Recently, with the spread of computers and the advance of information networks, electronic mail by which character information is transmitted and received across a network is spreading.

Files of various forms can be attached to electronic mail in addition to mail texts as character information, and Internet FAX (to be abbreviated as IFAX hereinafter) which transmits and receives images by attaching TIFF (Tag Image File Format) files to electronic mail is in widespread use. IFAX is an inter-apparatus communication technique by which an image read by the scanner of a transmitter is transmitted after converted into a TIFF image, and a receiver reproduces and prints out the TIFF image from received data.

When mail data of electronic mail is transmitted to a mail server by designating a plurality of addresses, the mail server delivers the mail to the individual designated addresses.

For example, there is a technique which transmits electronic mail by describing a plurality of destinations in the To, Cc, and Bcc fields of the mail. There is also a technique which transmits electronic mail by describing a plurality of destinations in the To, Cc, and Bcc fields of the mail. Furthermore, there is a technique which, when performing broadcast by mixing a plurality of FAX addresses and a plurality of IFAX addresses, adds data describing all pieces of address information.

In the Internet FAX, as in the conventional FAX, an image header describing the transmission date and time, sender information, recipient information, and page number information is desirably added to the leading edge of a scanned image.

In the conventional techniques as described above, however, the electronic mail addresses of the recipients are described in the To and Cc fields. Therefore, each recipient can determine to whom the electronic mail has been transmitted, by printing out the mail addresses. On the other hand, no recipient information can be added to the image header because all data to be transmitted must be the same data.

When a mail server has received electronic mail for which a plurality of addresses are designated, this mail server must delivers the mail data to each address, and this increases the load on the mail server. Accordingly, RFC2821 defines that a mail server must process mail for which at least 100 addresses are designated at once.

A mail server, therefore, is not always capable of delivering mail having more than 100 addresses, and whether this is possible depends upon the design of each mail server.

### SUMMARY OF THE INVENTION

The present invention has been made to solve the above problems, and provides an image communication apparatus which describes the mail addresses of all recipients in electronic mail address fields To, Cc, and Bcc, thereby allowing each recipient to confirm to whom this electronic mail has been broadcast, and which can also add the transmission date and time, sender information, recipient information, and page number information to the header portion of a scanned image.

The present invention also provides an image communication apparatus which, when transmitting electronic mail to addresses expected to exceed the number of addresses to which a mail server can simultaneously broadcast electronic mail, describes the mail addresses of all recipients in electronic mail address fields To, Cc, and Bcc, thereby allowing each recipient to determine to whom this electronic mail has been transmitted, and which can also safely transmit electronic mail independently of the number of addresses to which a mail server can simultaneously broadcast electronic mail.

According to one aspect of the present invention, preferably, an image communication apparatus comprises:
image reading unit arranged to read an image and convert the read image into electronic data;
transmission address input unit capable of designating a plurality of destinations;
address field forming unit arranged to form an electronic mail address field describing all the addresses designated by the destination input unit;
image header adding unit arranged to add address information of at least one address to the image read by the image reading unit, thereby generating a synthesized image;
electronic mail data forming unit arranged to form electronic mail data on the basis of the electronic mail address field and the synthesized image obtained by the image header adding unit; and
transmitting unit arranged to transmit the electronic mail data formed by the electronic mail data forming unit to each destination.

According to another aspect of the present invention, preferably, an image communication apparatus comprises:
image reading unit arranged to read an image and convert the read image into electronic data;
transmission address input unit capable of designating a plurality of destinations;
address field forming unit arranged to form an electronic mail address field describing all the addresses designated by the destination input unit;
electronic mail data forming unit arranged to form electronic mail data on the basis of the electronic mail address field formed by the address field forming unit, and the image read by the image reading unit; and
transmitting unit arranged to transmit the electronic mail formed by the electronic mail data forming unit for each predetermined address unit a plurality of number of times.

According to another and further aspect of the present invention, preferably, an image communication method comprises:
an image reading step of reading an image and converting the read image into electronic data;
a transmission address input step capable of designating a plurality of destinations;
an address field formation step of forming an electronic mail address field describing all the addresses designated in the destination input step;
an image header addition step of adding address information of at least one address to the image read in the image reading step, thereby generating a synthesized image;
an electronic mail data formation step of forming electronic mail data on the basis of the electronic mail address field and the synthesized image obtained in the image header addition step; and
a transmission step of transmitting the electronic mail data formed in the electronic mail data formation step to each destination.

According to another and further aspect of the present invention, preferably an image communication method comprises:
an image reading step of reading an image and converting the read image into electronic data;
a transmission address input step capable of designating a plurality of destinations;
an address field formation step of forming an electronic mail address field describing all the addresses designated in the destination input step;
an electronic mail data formation step of forming electronic mail data on the basis of the electronic mail address field formed in the address field formation step, and the image read in the image reading step; and
a transmission step of transmitting the electronic mail formed in the electronic mail data formation step for each predetermined address unit a plurality of number of times.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view for explaining a network connection configuration;

FIG. 2 is a block diagram showing a system configuration;

FIG. 3 is a view showing a program configuration;

FIG. 4 is a view for explaining transmission settings;

FIG. 5 is a view for explaining an address book;

FIGS. 6A and 6B are views for explaining the receiver capability settings in the address book;

FIG. 7 is a flowchart for explaining an IFAX transmitting operation according to the first embodiment;

FIGS. 8A and 8B are views for explaining transmission images according to the first embodiment;

FIG. 9 shows electronic mail data to be transmitted according to the first embodiment;

FIG. 10 shows electronic mail data to be transmitted according to the first embodiment;

FIG. 11 is a view for explaining an SMTP by which an MFP 100 and a mail server according to the present invention communicate with each other;

FIG. 12 is a view for explaining the transmission settings of MFPs 100 and 101 according to the second embodiment;

FIG. 13 is a flowchart for explaining an e-mail transmitting operation according to the second embodiment;

FIG. 14 shows electronic mail data according to the second embodiment; and

FIG. 15 is a view for explaining an SMTP protocol according to the second embodiment.

### DETAILED DESCRIPTION OF THE PREFERRED EMBODIMENTS

### First Embodiment

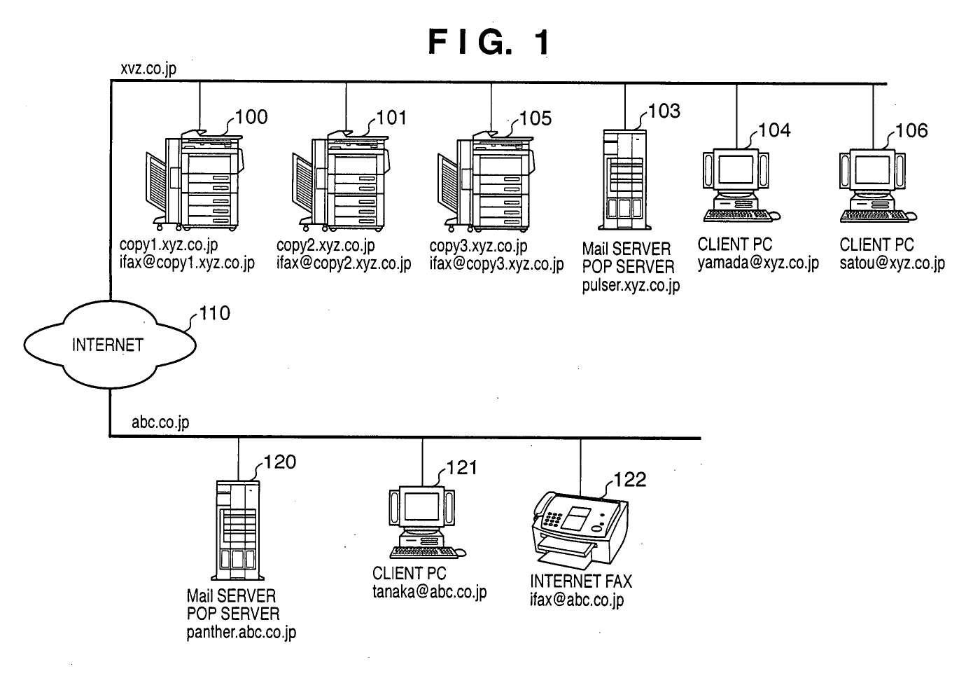

The first embodiment of the present invention will be described below with reference to the accompanying drawings. FIG. 1 is a block diagram showing the network connection configuration of an embodiment of a communication apparatus as the present invention.

MFPs (Multi Function Peripherals) 100 and 101 are multi-function copying machines each including a scanner, printer, and the like, and having a copy function, a FAX transmitting/receiving function, and a printer function of printing data formed on a computer. The MFPs 100 and 101 are connected to a network having a domain name xyz.co.jp, and connected to computers and network apparatuses such as an authentication server 102, mail server/POP server 103, and client PC 104.

This network is further connected to the Internet 110 covering the whole world, and is also connected to a network called abc.co.jp to which a mail server/POP server 120, client PC 121, and Internet FAX 122 are connected.

The MFP 100 is given a host name copy1.xyz.co.jp and an electronic mail address ifax@copy1.xyz.co.jp. The MFP 101 is given a host name copy2.xyz.co.jp and an electronic mail address ifax@copy2.xyz.co.jp.

When the user turns on the power supply of the client PC 104, he or she is requested to enter the user name and password. When the user name and password are entered, an authentication server (not shown) is inquired of about whether the user name and password are valid. If the user is a registered user, he or she can use the client PC 104 by the authenticated user name.

Generic electronic mail software is installed in the PC 104, and the PC 104 is given a mail address yamada@xyz.co.jp. Likewise, the PC 106 is given a mail address satou@xyz.co.jp.

The mail server/POP server 103 has functions of both a mail server and POP server. The mail server/POP server 120 also has similar functions.

When electronic mail is to be transmitted from the client PC 104 to tanaka@abc.co.jp, electronic mail data formed by the electronic mail software of the client PC 104 is transmitted to the mail server 103 by an SMTP (Simple Mail Transfer Protocol). The mail server 103 transmits the electronic mail data to the mail server 120 across the Internet 110 by the SMTP. The electronic mail data is stored in the mail box of tanaka@abc.co.jp.

Generic electronic mail software is installed in the client PC 121 as well. The client PC 121 monitors, at predetermined intervals, whether electronic mail has arrived at the mail box of tanaka@abc.co.jp in the POP server 120, by using a POP3 (Post Office Protocol-Version 3). If mail has arrived at the POP server 120, the mail data is received.

Mail from tanaka@abc.co.jp of the client PC 121 to syain1@xyz.co.jp of the client PC 104 is transmitted by the reverse route. That is, mail data formed by the generic electronic mail software of the PC 121 is transmitted to the mail server 103 via the mail server 120, and stored in the mail box of syain1@xyz.co.jp of the POP server 103.

The client PC 104 so operates as to acquire the received mail data from the mail box of syain1@xyz.co.jp by the POP3.

The MFPs 100 and 101 have an e-mail transmission mode and IFAX transmission mode. In the e-mail transmission mode, an image received by the FAX/IFAX receiving function and a monochrome/color image scanned by the scanner are transmitted on the assumption that they are sent to a general electronic mail address. The IFAX transmission mode is based on the assumption that these images are transmitted to an apparatus based on the IFAX standard. Transmission and reception are performed using the SMTP and POP3, and operations similar to transmission/reception of the client PCs 104 and 121 described above are performed.

When a color image is scanned by the scanner in the e-mail transmission mode, an image of a JPEG format or an image of a PDF (Portable Document Format) file can be transmitted. When a monochrome image is read, a TIFF or PDF image can be transmitted.

When mail is transmitted to the mail address syainl@xyz.co.jp, the client PC 104 receives this mail by using the POP3. The image can be displayed by a universal image viewer.

In the IFAX transmission mode, an image scanned by the scanner is transmitted as a TIFF image based on RFC2301 to the MFP 100 or 101 or Internet FAX 122 based on the IFAX standard by the SMTP or POP3. The image data received by the scanner or FAX/IFAX receiving function of the transmitter is received by a receiver in a remote place, and the received image is printed at a printer.

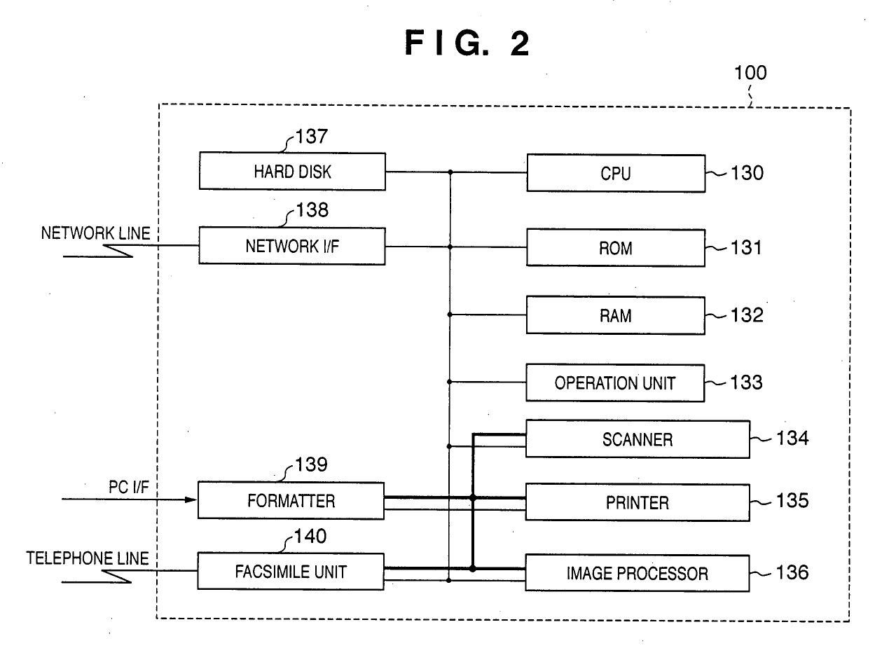

FIG. 2 is a view showing the arrangement of the MFP 100.

A CPU 130 is a control circuit which controls the entire system by using programs stored in a ROM 131 and memories of a RAM 132. An operation unit 133 includes an LCD display panel and hardware keys such as a start key and ten keys. The operation unit 133 is a circuit which displays software buttons on the LCD, and detects a button touched by the user's finger, thereby smoothly executing a user operation.

A scanner 134 is a circuit which converts image data of an original into electronic data by photoelectronic conversion. When an original is conveyed from a document feeder onto a platen glass, a lamp is turned on, and a scanner unit starts moving to expose and scan the original. The reflected light from the original is guided to a CCD image sensor by a mirror and lens, and converted into an electronic signal. This signal is converted into digital data by an A/D converter. When scanning of the original is completed, the original on the platen glass is discharged.

A printer 135 is a circuit which prints electronic image data on a printing sheet. That is, the printer 135 causes a laser emitting unit to emit a laser beam corresponding to electronic image data. A photosensitive drum is irradiated with this laser beam, and a latent image corresponding to the laser beam is formed on the photosensitive drum.

A developing device adheres a developing agent to the latent image on the photosensitive drum. At a timing synchronized with the start of laser beam irradiation, a printing sheet is fed from a paper feed cassette and conveyed to a transfer portion where the developing agent adhered to the photosensitive drum is transferred to the printing sheet. This printing sheet having the developing agent is conveyed to a fixing unit, and the developing agent is fixed on the printing sheet by heat and pressure of the fixing unit. The printing sheet from the fixing unit is discharged by a discharge roller. A sorter sorts printing sheets by storing each discharged printing sheet into a corresponding bin.

An image processor 136 includes a large-capacity image memory, image rotating circuit, resolution conversion circuit, and encoding/decoding circuits of, e.g., MH, MR, MMR, JBIG, and JPEG. The image processor 136 can execute various image processing operations such as shading, trimming, and masking.

A hard disk 137 is a large-capacity recording medium connected by an I/F such as an SCSI or USB. This recording medium may also be another recording medium such as an MO, rather than a hard disk.

A network I/F 138 is a circuit which executes a network data link for connecting to a network such as the Ethernet, e.g., 10BASE-T or 100BASE-T, or Token Ring.

A formatter 139 includes a parallel interface based on IEEE1284, and a PC I/F circuit such as a USB. The formatter 139 is a rendering circuit which forms image data from PDL (Page Description Language) data received by the PC I/F circuit or network I/F circuit and transmitted from a personal computer. The image processor 136 processes this image data, and the printer 135 prints out the processed data.

A facsimile unit 140 is a facsimile I/F circuit which connects to a telephone line, and includes circuits such as an NCU (Network Control Unit) and MODEM (MOdulator/DEModulator).

Image data scanned by the scanner 134 is processed by the image processor 136 and transmitted to another FAX via a telephone line, or data transmitted from another FAX is received, processed by the image processor 136, and printed by the printer 135.

The scanner 134, printer 135, image processor 136, formatter 139, and facsimile unit 140 are connected by a high-speed video bus different from a CPU bus from the CPU 130, and capable of transmitting image data at high speed.

A copy function is implemented by an operation by which image data scanned by the scanner 134 is processed by the image processor 136 and printed by the printer 135.

The MFP 100 has a send function by which image data scanned by the scanner 134 is processed by the image processor 136 and transmitted to the network from the network I/F, or an IFAX function by which an image based on RFC2301 is formed by the image processor 136 and data is transmitted or received by the electronic mail protocol.

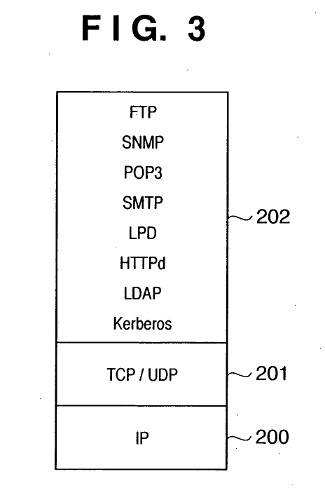

FIG. 3 is a view for explaining the network program configuration of the MFP 100.

This program configuration is roughly divided into three layers: an IP (Internet Protocol) 200, TCP (Transmission Control Protocol)/UDP (User Datagram Protocol) 201, and application layer program 202.

The IP 200 is an Internet protocol layer which provides a service for sending a message from a transmission host to a destination host in cooperation with a relay node such as a router. The IP 200 manages the addresses of transmission sources which transmit data and the addresses of destinations which receive data, and executes a routing function which manages a route in the network through which data is transmitted to a destination host in accordance with address information.

The TCP/UDP 201 is a transport layer which provides a service for sending a message from a transmitting application process to a receiving application process. The TCP is a connection type service, and warrants high reliability of communication. The UDP is a connectionless type service, and warrants no reliability.

The application layer protocol 202 defines a plurality of protocols including an FTP (File Transfer Protocol) as a file transfer service, an SNMP as a network management protocol, an LPD as a server protocol for printing by a printer, an HTTP as a protocol of the WWW (World Wide Web), an SMTP (Simple Mail Transfer Protocol) as an electronic mail transmission/reception protocol, a POP3 (Post Office Protocol-Version 3) as a mail download protocol, and an LDAP (Lightweight Directory Access Protocol) as a protocol for accessing a directory database which manages user's electronic mail addresses and the like. A Kerberos authentication program defined by RFC1510 is also included.

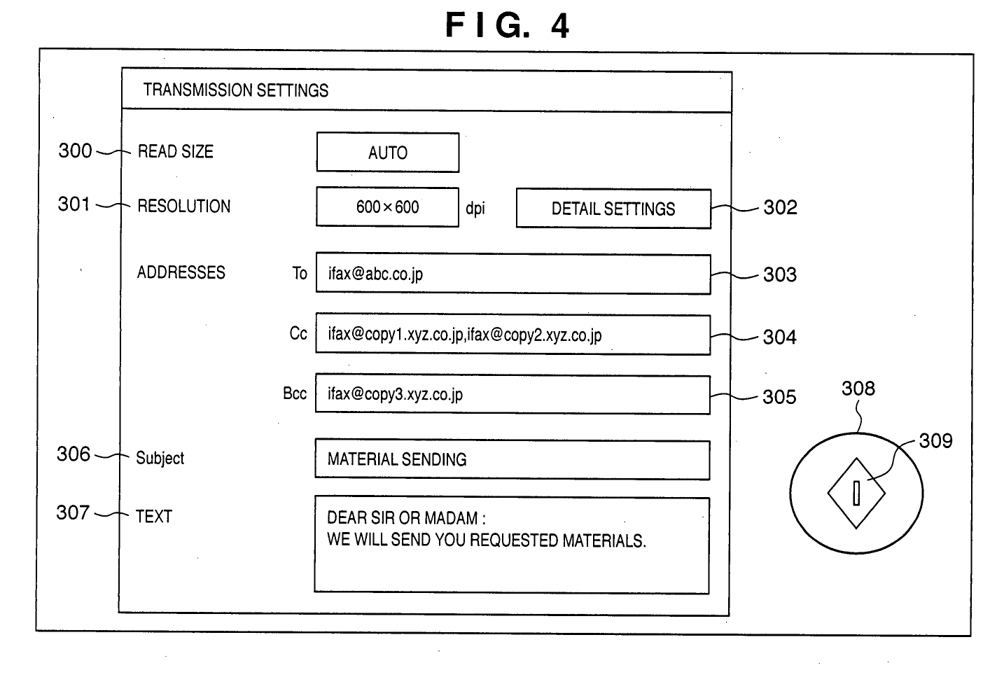

FIG. 4 shows a transmission setting window displayed on the operation unit 133 when image data scanned by the scanner 134 is to be transmitted by electronic mail. By read size 300, an original size to be read by the scanner 134 can be designated. It is possible to designate a paper size such as A3, A4, A5, B4, B5, 11×17, LTR, or STMT, and the direction of each paper size. “AUTO” is presently set, so an original is read by a value sensed by an original sensor of the scanner 134.

By resolution 301, a resolution when the scanner 134 reads an image can be designated. It is possible to designate one of 200×100, 200×200, 200×400, 300×300, 400×400, and 600×600 dpi. Although a default value is 200×200, 600×600 dpi is presently set. By detail settings 302, detailed operations of scanning can be designated. Examples are density setting, document type designation, both-side reading, page consecutive reading designation, and image quality adjustment.

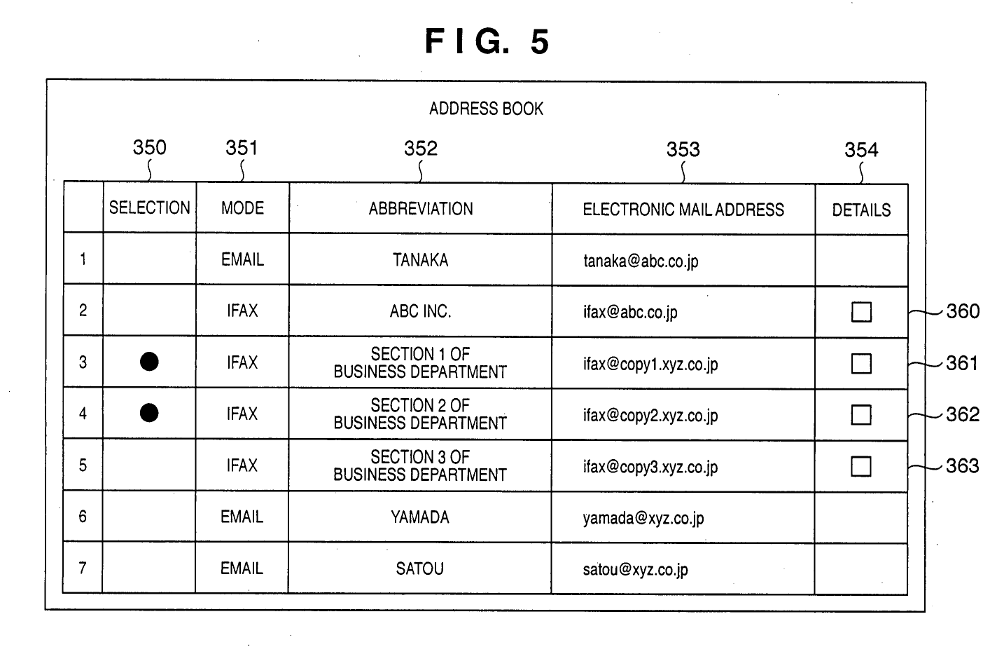

When address 303 is selected, a “To field” as the destination of electronic mail can be selected from addresses registered in an address book shown in FIG. 5. Similarly, when address 304 is selected, the address in a “Cc field” can be selected from addresses registered in the address book shown in FIG. 5. When address 305 is selected, the address in a “Bcc field” can be selected from addresses registered in the address book shown in FIG. 5. The address 303 using the address book will be explained later with reference to FIG. 5.

Note that the maximum number of destinations is 256, so the maximum total value of the addresses 303, 304, and 305 is 256. Addresses more than this number cannot be input. Subject 306 and text 307 are the title and mail text, respectively, attached to the electronic mail to be transmitted. When each setting column is selected, a software keyboard is displayed, so the user can input character strings.

A start key 307 is a hardware key located on the side of the operation unit 133. The user can drive the scanner 134 by pressing this key. Blue and red LEDs 308 are embedded in the center of the start key 307. If no destination is designated, the red LED emits light to notify the user that the scanner 134 cannot be driven even if the start key 307 is pressed. If at least one destination is designated, the blue LED emits light to notify the user that the scanner can be driven.

FIG. 5 shows the address book managing destination information.

This address book is a database which manages destinations in a user mode (not shown) for registering and managing various pieces of setting information of the apparatus. Registration, change, delete, and the like of a destination can be executed in this user mode.

The abbreviations of destinations are displayed in 352, and the electronic mail addresses are displayed in 353. The user selects a destination from these two columns.

Electronic mail is transmitted to addresses indicated by “●”, and the selected addresses are displayed in the addresses 303 to 305 and described in the individual fields of the electronic mail.

By MODE 351, it is possible to designate the e-mail transmission mode which transmits electronic mail on the assumption that the destination is a general electronic mail address, or the IFAX transmission mode based on the assumption that electronic mail is transmitted to an IFAX apparatus having an inter-apparatus transmitting/receiving function.

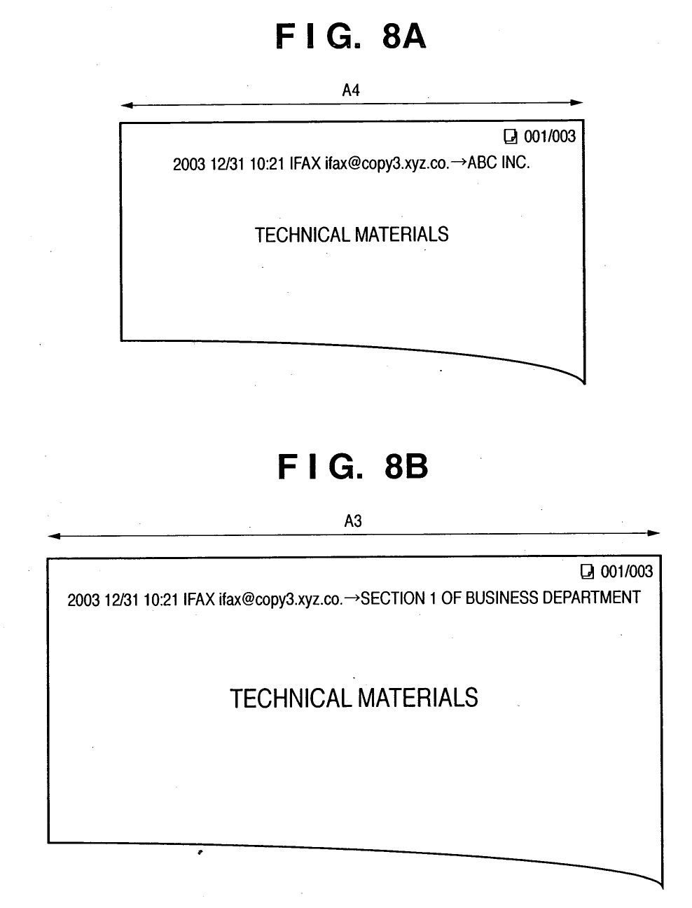

Electronic mail can be transmitted to an e-mail destination by the TIFF, JPEG, or PDF image format. However, only a TIFF file defined by RFC2301 can be transmitted to an IFAX destination. Also, in the e-mail transmission mode, images scanned by the scanner can be transmitted. In the IFAX transmission mode, however, the number of pixels in the main scan direction is determined. Therefore, predetermined image conversion is performed, and a header image to be described later with reference to FIG. 8 is added to the image. This header image describes the electronic mail addresses of the destination and transmission source, the transmission start time, and the page number, so that the user can understand the sender and recipient of the image.

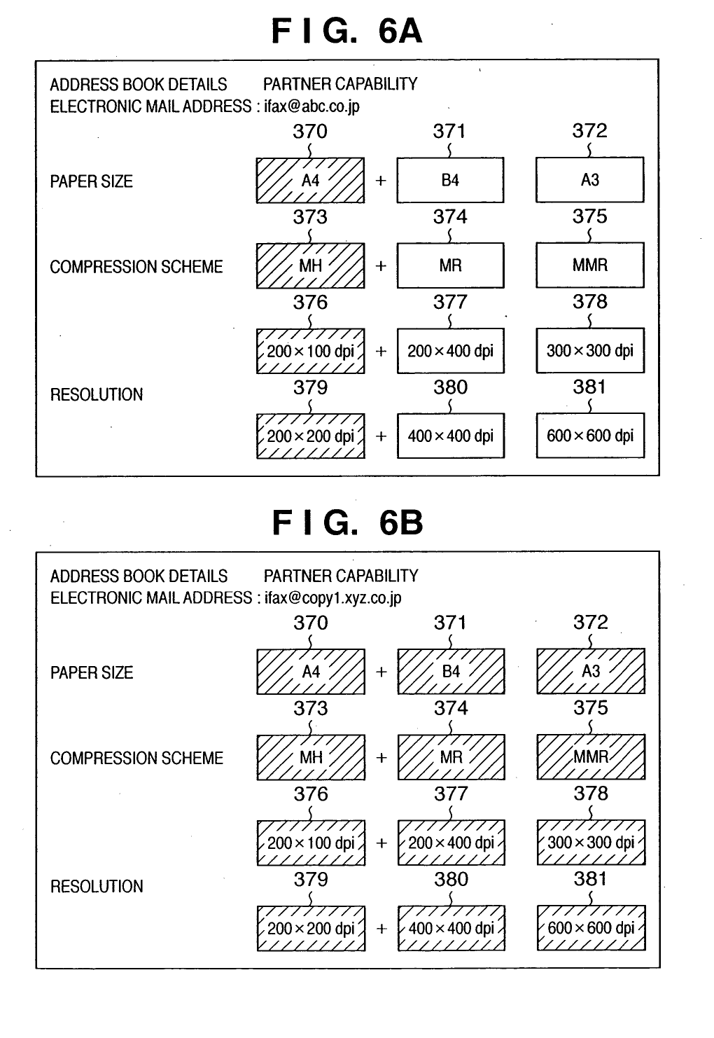

In details 354, “ ” is displayed as indicated by 360 to 363 when the MODE 351 is the IFAX transmission mode. By pressing this button, it is possible to designate the paper size, compression scheme, and resolution as the processing capability of each destination to be described later with reference to FIGS. 6A and 6B.

FIGS. 6A and 6B are windows for setting the processing capability of each destination in the IFAX transmission mode. These windows display the processing capability of a transmission destination (partner) for each of the paper size, compression scheme, and resolution. A supported mode is indicated in gray. The processing capability of a transmission destination is managed for each address in the address book (FIGS. 6A and 6B). Although the processing capability of each transmission destination must be input in the address book beforehand, it can be manually input by a sender or can also be acquired by communication between the transmission source and transmission destination. In this embodiment, the address book is managed by the RAM 132.

A paper size A4 370 is always supported by an IFAX apparatus, and hence is always selected and displayed in gray. This paper size cannot be set in an unselected state.

If a receiver can receive a B4-size image, B4 is selected and displayed in gray by pressing a B4 key 371. When the B4 key 371 is pressed again, B4 is set in an unselected state and is not displayed in gray any longer.

If a receiver can receive an A3-size image, A3 is selected and displayed in gray by pressing an A3 key 372. When the A3 key 372 is pressed again, A3 is set in an unselected state and is not displayed in gray any longer. By default settings, only A4 is selected as a paper size, and B4 and A3 are not selected. The selected paper size indicates a paper size which can be processed by a receiver in the destination.

MH 373 is a compression scheme always supported by an IFAX apparatus, and hence is always selected and displayed in gray. The MH 373 cannot be set in an unselected state.

If a receiver can receive an MR compressed image, MR is selected and displayed in gray by pressing an MR key 374. When the MR key 374 is pressed again, MR is set in an unselected state and is not displayed in gray any longer.

If a partner can receive an MMR compressed image, MMR is selected and displayed in gray by pressing an MMR key 375. When the MMR key 375 is pressed again, MMR is set in an unselected state and is not displayed in gray any longer. By default settings, only MH is selected as a compression scheme, and MR and MMR are not selected. The selected compression scheme indicates a compression scheme which can be processed by a receiver in the destination.

200×100 dpi 376 and 200×200 dpi 379 are resolutions supported by any IFAX apparatus, and hence are always selected and displayed in gray. These resolutions cannot be set in an unselected state.

If a receiver can receive a 200×400-dpi image, 200×400 dpi is selected and displayed in gray by pressing a 200×400 dpi key 377. When the 200×400 dpi key 377 is pressed again, 200×400 dpi is set in an unselected state and is not displayed in gray any longer.

If a receiver can receive a 300×300-dpi image, 300×300 dpi is selected and displayed in gray by pressing a 300×300 dpi key 378. When the 300×300 dpi key 378 is pressed again, 300×300 dpi is set in an unselected state and is not displayed in gray any longer.

If a receiver can receive a 400×400-dpi image, 400×400 dpi is selected and displayed in gray by pressing a 400×400 dpi key 380. When the 400×400 dpi key 380 is pressed again, 400×400 dpi is set in an unselected state and is not displayed in gray any longer.

If a receiver can receive a 600×600-dpi image, 600×600 dpi is selected and displayed in gray by pressing a 600×600 dpi key 381. When the 600×600 dpi key 381 is pressed again, 600×600 dpi is set in an unselected state and is not displayed in gray any longer. By default settings, only 200×100 dpi and 200×200 dpi are selected as resolutions, and the other resolutions are not selected. The selected resolutions indicate resolutions which can be processed by a receiver in the destination.

FIG. 6A shows a window for setting the detailed information 360 of the electronic mail address ifax@abc.co.jp. FIG. 6A indicates that the set processing capability includes only the default set values, i.e., the paper size is only A4, the compression scheme is only MH, and the resolutions are only 200×100 dpi and 200×200 dpi.

FIG. 6B shows a window for setting the detailed information 361, 362, or 363 of the electronic mail address ifax@copy1.xyz.co.jp, ifax@copy2.xyz.co.jp, or ifax@copy3.xyz.co.jp. FIG. 6B indicates that the set processing capability includes A4, B4, and A3 as receivable paper sizes, MH, MR, and MMR as receivable compression schemes, and 200×100 dpi, 200×200 dpi, 200×400 dpi, 300×300 dpi, 400×400 dpi, and 600×600 dpi as receivable resolutions.

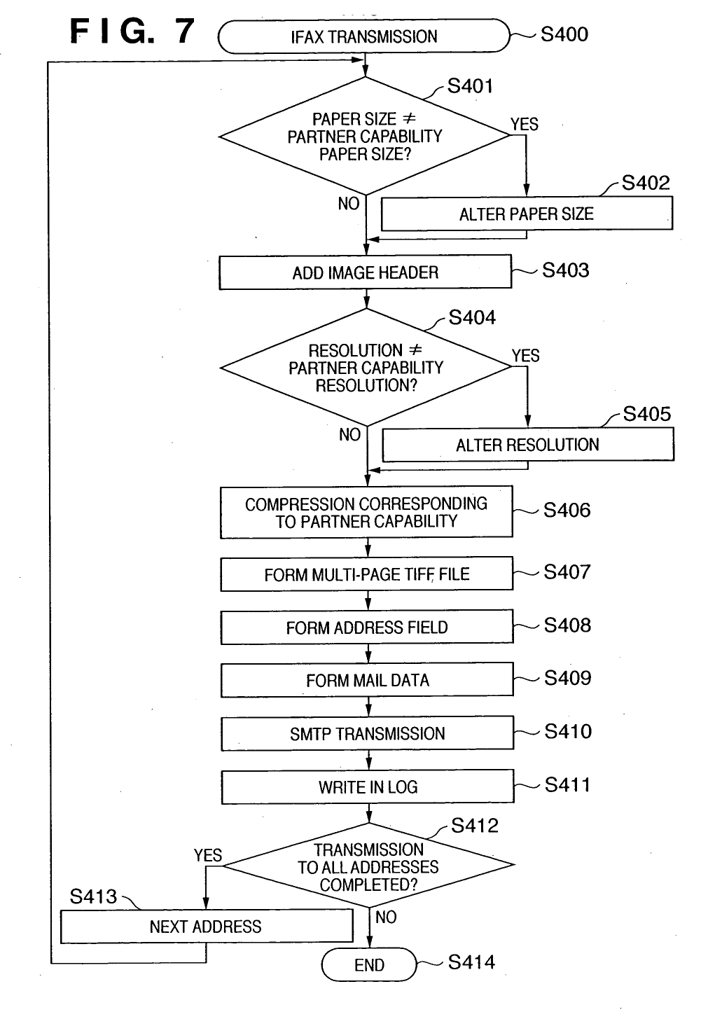

FIG. 7 is a flowchart for explaining an operation when the transmitting settings shown in FIG. 4 are performed and the start key 307 is pressed by the user, an original set by the user is read from the document feeder of the scanner 134, and the scanned original data is transmitted to an IFAX address.

A transmitting operation for IFAX addresses starts from step S400 and is performed for each destination.

In step S401, it is determined whether the paper size of an image read by the scanner 134 is set at the paper size of the partner capability explained with reference to FIGS. 6A and 6B. If the read paper size is not set at the partner capability, the flow advances to step S402 to perform paper size alteration by which the image read by the scanner 134 is altered to be smaller than the present paper size and equal to the maximum paper size set as the partner capability.

In step S403, an image header addition process is performed. In this process, an image describing the transmission start date and time, the abbreviation and electronic mail address of the sender, the abbreviation 352 of a partner as the recipient, and the page number shown in FIG. 8A or 8B is added to the image from the scanner 134.

In step S404, it is determined whether the resolution of the image to which the image header is added is set at the resolution of the partner capability explained with reference to FIGS. 6A and 6B. If the resolution of the scanned image is not set at the partner capability, the flow advances to step S405 to convert the image resolution to be smaller than the present resolution and equal to the maximum resolution set as the partner capability.

In step S406, compression is performed by a compression scheme having the highest compression ratio set as the partner capability. The compression ratios are MH<MR<MMR.

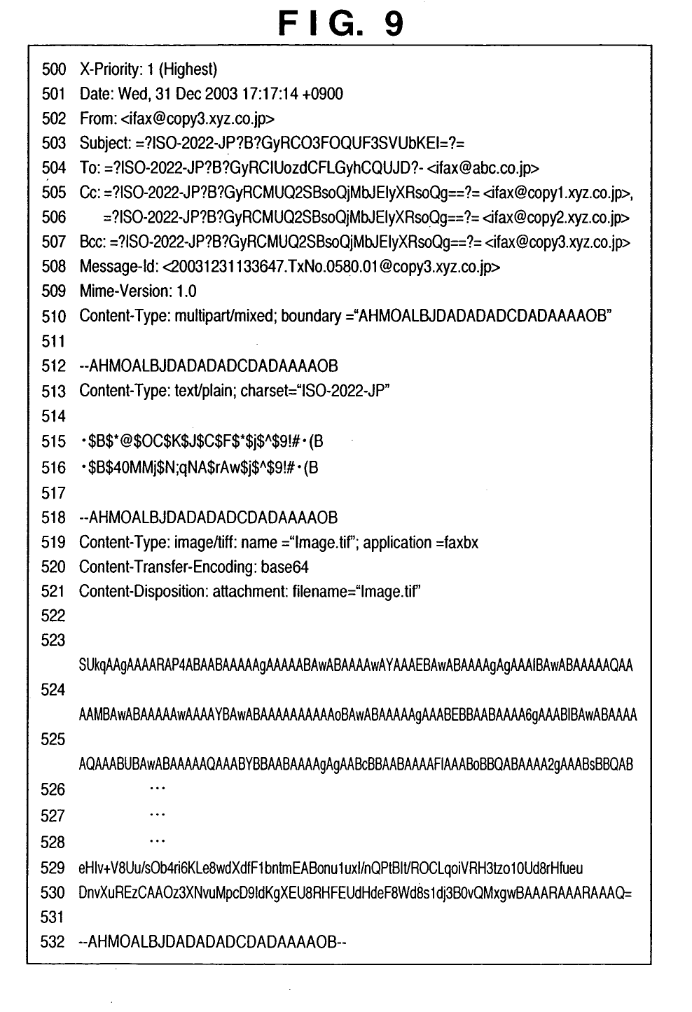

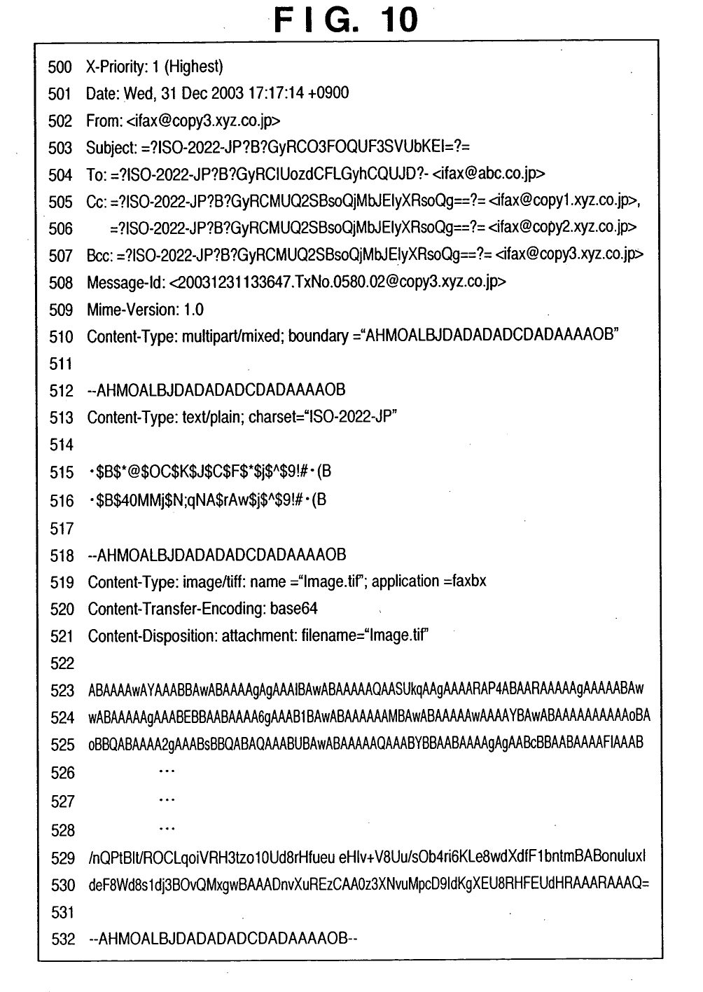

In step S407, a multi-page TIFF file is formed from the compressed image data containing a plurality of pages. Electronic mail data to be explained with reference to FIGS. 9 and 10 is formed in step S408 in which a mail header describing all destinations designated by 303, 304, and 305 is formed, and in step S409 which is a mail data formation step of encoding the multi-page TIFF file by BASE64.

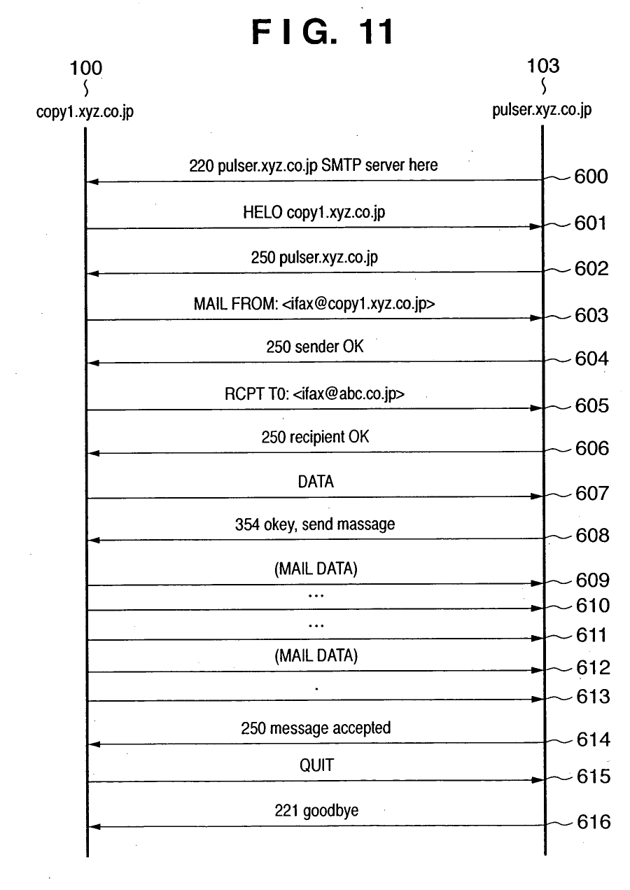

In step S410, the formed mail data is transmitted to the mail server by SMTP transmission. The processing of this SMTP transmission will be described later with reference to FIG. 11.

When the SMTP transmission is completed, the result is written in a log in step S411. Since the SMTP transmission is performed for each address, information such as the transmission start date and time, transmission result, transmission mode, and transmission data size is written in the log for each address. The registered log information is printed as a report such as a transmission result report indicating the transmission result or as a communication management report. This information can also be checked from the operation unit 133.

If a plurality of addresses are designated as destinations, it is determined in step S412 whether transmission to all the addresses is completed. If the transmission is not completed, the flow advances to step S413 to change the destination to the next address and execute the above transmitting operation for the number of destinations. If the transmitting operation to all the addresses is completed, the flow advances to step S414 to terminate the IFAX transmitting operation.

FIGS. 8A and 8B are views for explaining image data transmitted to each address when an A3-size, 600×600-dpi image is scanned from the scanner 134.

FIG. 8A shows image data to be transmitted to ifax@abc.co.jp in which the maximum paper size of the receiver capability is A4. An image header describing the transmission start date and time, the transmission source electronic mail address, “ABC Inc.” as the abbreviation 352 of ifax@abc.co.jp which receives the data, and the page number is added to the image scanned by the scanner 134. The length in the main scan direction of the image is the A4 size in accordance with the paper size of the receiver capability.

Since the resolution of the receiver capability is 200×200 dpi and the compression scheme of the receiver capability is MH, this image data is compressed at a resolution of 200×200 dpi by the compression scheme MH.

FIG. 8B shows image data to be transmitted to ifax@copy3.xyz.co.jp in which the maximum paper size of the receiver capability is A3.

An image header describing the transmission start date and time, the transmission source electronic mail address, “Section 1 of Business Department” as the abbreviation 352 of ifax@copy1.xyz.co.jp which receives the data, and the page number is added to the image scanned by the scanner 134. The length in the main scan direction of the image is the A3 size in accordance with the paper size of the receiver capability.

Since the resolution of the receiver capability is 600×600 dpi and the compression scheme of the receiver capability is MMR, this image data is compressed at a resolution of 600×600 dpi by the compression scheme MMR.

Other destinations ifax@copy2.xyz.co.jp and ifax@copy3.xyz.co.jp each have 600×600 dpi and the compression scheme MMR as the receiver capability. Therefore, image data compressed at a resolution of 600×600 dpi by the compression scheme MMR and having the A3 size in the main scan direction is formed. Characters in the destination abbreviation 352 described in the image header are “Section 2 of Business Department” or “Section 3 of Business Department”. Note that although the destination abbreviation is used as the destination information described in the image header, the electronic mail address may also be used.

In this embodiment as described above, if it is known that the receiver of a partner A (e.g., section 1 of business department) supports A3, B4 and A3 are displayed in gray (effective). As a consequence, an image scanned by A3 can be transmitted by A3. On the other hand, if the processing capability of a partner B (e.g., ABC Inc. described above which supports only A4) supports only A4 or is totally unknown, A4 as a default value is kept set. Consequently, an image scanned by A3 is transmitted after altered from A3 to A4. Accordingly, even when a plurality of partners are designated, data can be transmitted by one scanning operation.

FIG. 9 shows mail data formed in step S408 and transmitted to ifax@abc.co.jp. In the IFAX transmission mode, Priority: is set to Highest so that processing is immediately performed by the mail server, and a Date field indicating the transmission time is set in 501.

In 502, the electronic mail address ifax@copy3.xyz.co.jp of the sender is set as a From address. The characters “material sending” designated in Subject 306 are coded into a JIS code and encoded by BASE64. The encoded data is registered in a Subject field 503 as encoded-word data defined by RFC2047.

The address ifax@abc.co.jp is designated as the mail address of a To field 504, and “ABC Inc.” of the abbreviation 352 is described as encoded-word data in the same manner as for Subject.

In Cc fields 505 and 506 and a Bcc field 507, the addresses To 303, Cc 304, and Bcc 305 are designated, and the mail addresses and the abbreviations 352 are described as encoded-word data.

Note that data indicating the destinations 504 to 506 is described in all data transmitted to these addresses. Therefore, each recipient can determine to whom the data has been transmitted, except for the Bcc field. Since the maximum number of destinations is 256, the maximum total number of addresses described in the To field 504, Cc field 505, and Bcc field 507 is 256.

In a Message-Id field 508, data formed from the transmission date and time, the transmission receipt number, and the domain name of the transmitter is described. Since this data changes from one mail to another, no identical Message-Id's exist.

A MIME identifier in 509 and 510 indicates the version of MIME and also indicates that mail data is divided by a character string “AHMOALBJDADADADCDADAAAAOB”. 512 indicates a delimiter of the data. 513 indicates that the text is written by a JIS code.

515 and 516 indicate the described text in which the character string designated by the text 307 is described in a JIS code.

518 is a delimiter which indicates the end of the text and the start of a next delimiter. 519 to 521 indicate that the next data is an attached file obtained by encoding a TIFF file having a file name “Image.tif” by BASE64.

523 to 530 indicate data obtained by converting the image data explained with reference to FIGS. 8A and 8B into a TIFF file, and encoding the file by BASE64. The image header of this data changes from one address to another, and the resolution, paper size, and compression scheme change in accordance with the capability of a receiver. Therefore, the data changes from one address to another. 532 indicates the final delimiter of the data region 510.

FIG. 10 shows mail data to be transmitted to ifax@copy1.xyz.co.jp. A Message-Id 508 differs from the Message-Id 508 shown in FIG. 9, indicating that two mail data are different.

Address information in To 504, Cc 505 and 506, and Bcc 507 is common to destinations, and hence is the same as in ifax@abc.co.jp shown in FIG. 9. Data from 561 to 568 obtained by encoding an attached TIFF file by BASE64 differs from the data from 523 to 530, because the character string data of the image header and the resolution, paper size, and compression scheme of the receiver capability differ from ifax@abc.co.jp.

FIG. 11 is a view for explaining the SMTP transmission in step S409. When the copy1.xyz.co.jp MFP 100 as an SMTP client connects to pulser.xyz.co.jp (the mail server 103) as an SMTP server, an opening message beginning with “220” in 600 is returned to initialize the SMTP session.

When the MFP 100 transmits an HELO command in 601, the mail server 103 returns a response code 602 beginning with “250” and indicating “normal”. After that, the MFP 100 notifies the electronic mail address ifax@copy1.xyz.co.jp of the sender by a MAIL FROM command 603 indicating the sender. The mail server 103 returns a response code 604 beginning with “250” and indicating “normal”.

When the MFP 100 notifies the electronic mail address ifax@abc.co.jp of the recipient by an RCPT TO command 605 indicating the recipient, the mail server 103 returns a response code 606 beginning with “250” and indicating “normal”. The MFP 100 then transmits a DATA command 607 which notifies that mail data is to be transmitted. After making preparations, the mail server 103 returns a response code 608 beginning with “354”.

When notified that the mail server 103 has prepared for data reception, the MFP 100 transmits, from 609 to 612, the electronic mail data explained with reference to FIGS. 9 and 10 to the mail server 103.

When the whole electronic mail data is completely transmitted, “.” indicating the data end is transmitted in 613. The mail server 103 having received the data end code 613 transmits a response code 614 beginning with “250” and indicating “normal”, thereby notifying that the data is normally received.

Since the data transmission is normally processed, copy1.xyz.co.jp as the SMTP client transmits a QUIT command 615 to the mail server 103 to notify termination of the connection. Accordingly, the mail server 103 transmits a response code 616 beginning with “221” and indicating “normal”, thereby terminating the connection.

### Second Embodiment

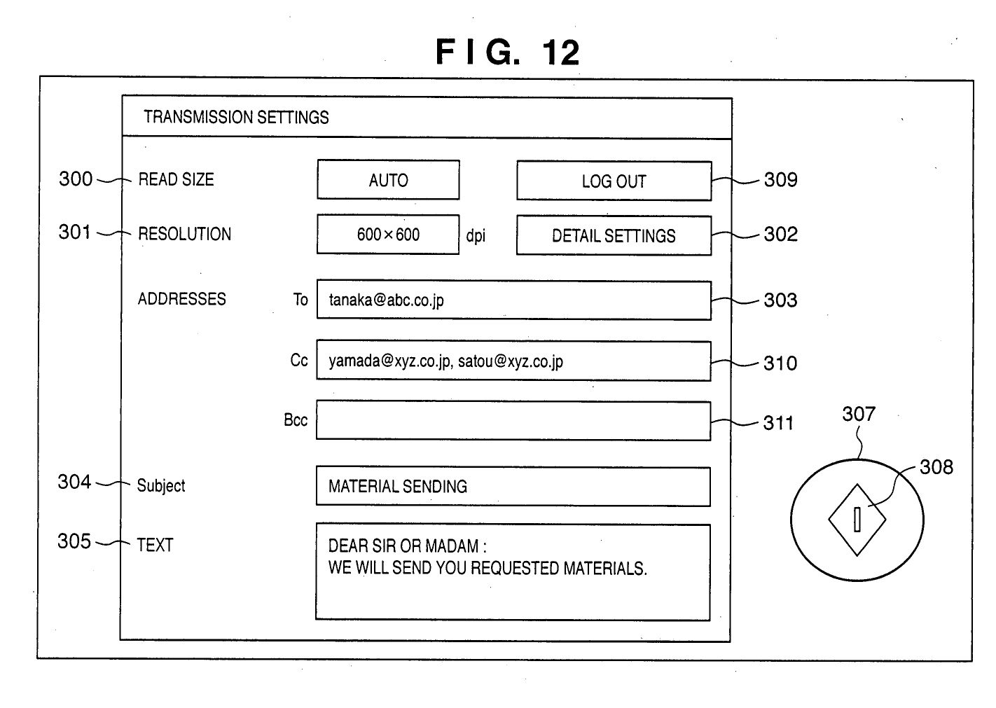

FIG. 12 shows the second embodiment of the present invention. FIG. 12 is a view for explaining an e-mail transmitting operation based on the assumption that the destination is a PC client.

Referring to FIG. 12, tanaka@abc.co.jp as the electronic mail address of a client PC 121 is set in address 303 which is set in the To field address of electronic mail, tanaka@abc.co.jp as the electronic mail address of the client PC 121 and satou@xyz.co.jp as the electronic mail address of a PC 106 are set in address 310 which is set in the Cc field address of the electronic mail, and nobody is set in address 311 which is set in the Bcc field address of the electronic mail.

Note that the maximum number of destinations is 256, so the maximum total number of the addresses 303, 310, and 311 is 256, and addresses more than this number cannot be input.

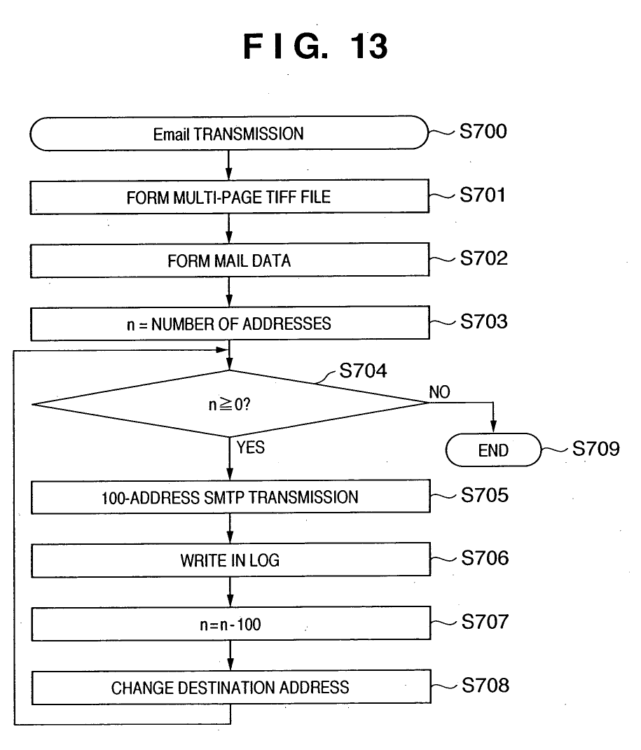

FIG. 13 is a flowchart for explaining an operation in which the transmission settings shown in FIG. 12 are performed by the user, a start key 307 is pressed, an original set by the user is read from a document feeder of a scanner 134, and the read original data is transmitted to the set e-mail addresses.

RFC2821 which defines the SMTP of electronic mail defines that a mail server must process mail having 100 addresses. Since, however, there is no definition for mail having more than 100 addresses, a mail server incapable of delivering mail having more than 100 addresses can exist. In SMTP delivery for e-mail transmission, mail delivery is performed for every 100 addresses. An operation of transmission to e-mail addresses starts from step S700, and the operation is not performed for each destination unlike in IFAX transmission. That is, one electronic mail data describing all addresses is formed, and the formed mail data is transmitted to a mail server. The mail server delivers the electronic mail to each address.

Step S701 is a process of compressing a scanned image, and forming a multi-page TIFF file from the image data containing a plurality of pages. The compression scheme is MMR compression (fixed), and no such image header as used in IFAX transmission is added.

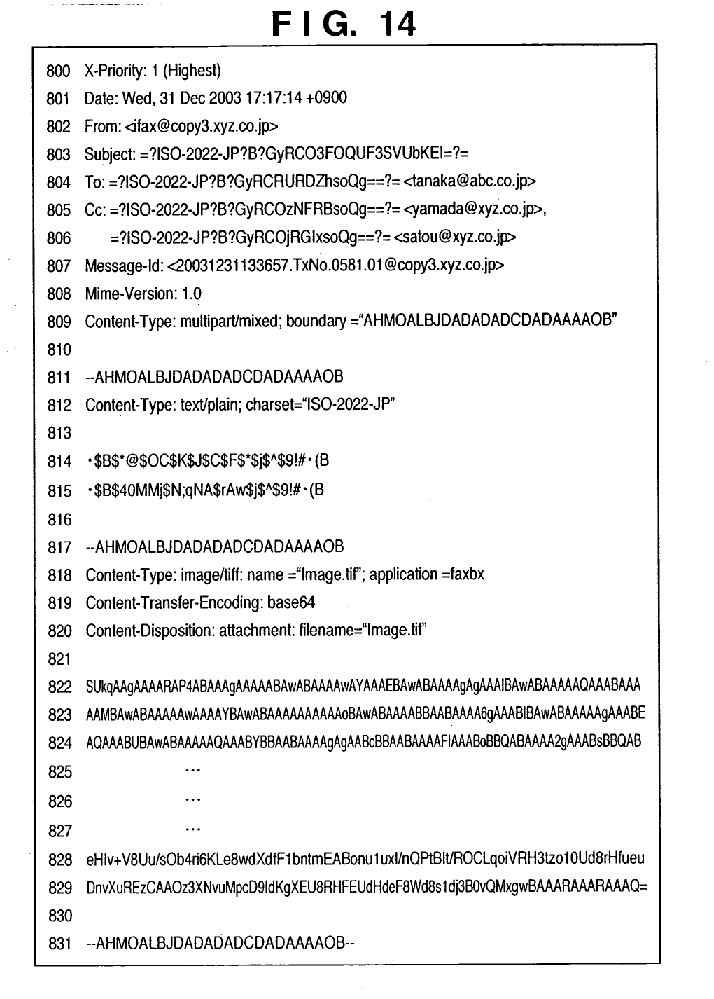

Step S702 is a mail data formation process of forming electronic mail data to be described later with reference to FIG. 14. This process includes, e.g., a process of forming a mail header describing all the destinations designated in all of 303, 304, and 305, and a process of encoding the multi-page TIFF by BASE64.

In step S703, the number of all addresses is substituted as an initial value for a variable n.

In step S704, whether the variable n is larger than 0 is determined. If the variable n is larger than 0, 100-address SMTP transmission in step S705 is performed. If the variable n is smaller than 0, the e-mail transmission process is terminated (step S709).

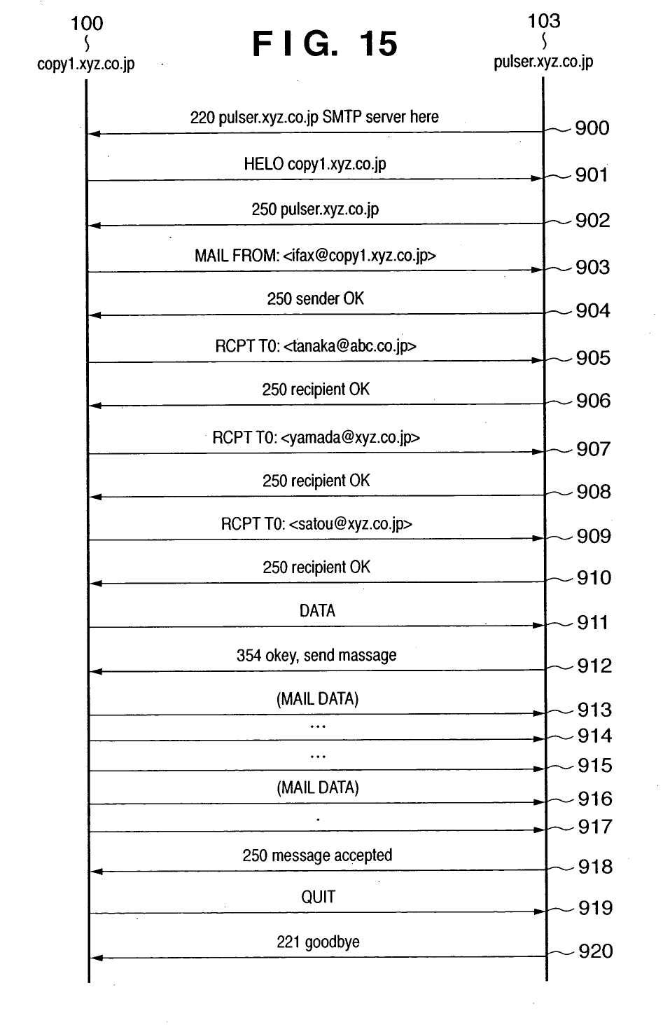

Step S705 performed when the variable n is larger than 0 is a process, to be described later with reference to FIG. 15, by which the formed electronic mail data is transmitted to a mail server in accordance with the SMTP. This process can transmit mail to a maximum of 100 addresses.

When the transmitting operation is terminated, the result is written in a log (step S704), and 100 is subtracted from the variable n (step S707).

Destination change in step S708 is a process which, if more than 100 destinations are designated, changes the destinations from addresses to which the mail has been transmitted in step S705 to a maximum of 100 addresses to which the mail has not been transmitted yet. There is no more destination if the mail has been transmitted to all the destinations.

When destination change step S708 is completed, the flow returns to step S704 to determine whether the variable n is larger than 0.

Accordingly, if 256 destinations as the maximum number are designated, 256 is initially set in the variable n. When transmission to the first 100 addresses from 1 to 100 is completed in step S705, the variable n becomes 156, and the next 100 addresses from 101 to 200 are set in step S708. Then, the flow returns to step S704.

Since the value of the variable n is 156, transmission to the 101st to 200th addresses is performed in step S705. Consequently, the variable n becomes 56, the 201st to 256th addresses are set as destinations, and the flow returns to step S704.

Since the value of the variable n is 56, transmission to the 201st to 256th addresses is performed in step S705. As a consequence, the variable n becomes −44, so no destination is set, and the transmitting operation is terminated in accordance with determination in step S704. As described above, when 256 destinations are registered, mail data is transmitted to all the addresses by performing the transmitting operation three times.

Since all the addresses are described in the transmission data of the electronic mail transmitted in this case, each recipient having received this mail can determine to whom the sender has sent the mail, except for the addresses described in the Bcc field.

FIG. 14 is a view for explaining the electronic mail data formed in step S702.

Priority: is set to Highest in 800 so that processing is immediately performed by the mail server, and a Date field indicating the transmission time is set in 801.

In 802, the electronic mail address ifax@copy3.xyz.co.jp of the sender is set in a From address. Characters “material sending” designated in Subject 306 are coded into a JIS code and encoded by BASE64. The encoded data is registered in a Subject field 803 as encoded-word data defined by RFC2047.

The address tanaka@abc.co.jp is designated as the mail address of a To field 804, and “Tanaka” of an abbreviation 352 is described as encoded-word data in the same manner as for Subject. In a Cc field 805, the mail address yamada@xyz.co.jp designated by the address 304 and “Yamada” as the abbreviation 352 are described as encoded-word data. In 806, the mail address satou@xyz.co.jp designated by an address 304 and “Satou” as the abbreviation 352 are described as encoded-word data.

Note that data indicating the destinations 804 to 806 is described in all data transmitted to these addresses. Therefore, each recipient can determine to whom the data has been transmitted. Since the maximum number of destinations is 256, the maximum total number of addresses described in the To (address) field 804, the Cc (broadcast address) field 805, and a Bcc (anonymous broadcast) field which is not set this time is 256.

In a Message-Id field 808, data formed from the transmission date and time, the transmission receipt number, and the domain name of the transmitter is described. If mail data to be transmitted are different, no identical Message-Id's exist. If more than 100 destinations are designated, mail data to be transmitted are the same, so mail data having the same Message-Id is transmitted.

A MIME identifier in 809 and 810 indicates the version of MIME and also indicates that mail data is divided by a character string “AHMOALBJDADADADCDADAAAAOB”.

811 is the start of a delimiter of the data, and indicates that the mail data delimited by 812 is a text written by a JIS code.

814 and 815 indicate the text in which the character string designated by the text 307 is coded into a JIS code. 817 is a delimiter of the data, and indicates the end of the text and the start of a next delimiter. 818 to 820 indicate that data in the delimited region is an attached file obtained by encoding a TIFF file having a file name “Image.tif” by BASE64.

822 to 829 indicate data obtained by converting image data scanned by the scanner 134 into a TIFF file, and encoding the file by BASE64. 831 indicates the final delimiter of the data region 809.

FIG. 15 is a view for explaining the 100-address SMTP transmission in step S705.

When a copy1.xyz.co.jp MFP 100 as an SMTP client connects to pulser.xyz.co.jp (a mail server 103) as an SMTP server, an opening message beginning with “220” in 900 is returned to initialize the SMTP session.

When the MFP 100 transmits an HELO command in 901, the mail server 103 returns a response code 902 beginning with “250” and indicating “normal”. After that, the MFP 100 notifies the electronic mail address ifax@copy1.xyz.co.jp of the sender by a MAIL FROM command 903 indicating the sender. The mail server 103 returns a response code 904 beginning with “250” and indicating “normal”.

When the MFP 100 notifies the electronic mail address tanaka@abc.co.jp of the recipient by an RCPT TO command 905 indicating the recipient, the mail server 103 returns a response code 906 beginning with “250” and indicating “normal”.

When the MFP 100 notifies the electronic mail address yamada@xyz.co.jp of the next recipient by an RCPT TO command 907, the mail server 103 returns a response code 908 beginning with “250” and indicating “normal”. When the MFP 100 notifies the electronic mail address satou@xyz.co.jp of the third recipient by an RCPT TO command 909, the mail server 103 returns a response code 910 beginning with “250” and indicating “normal”.

Since transmission by this SMTP can be performed for a maximum of 100 addresses, an RCPT TO command is issued 100 times if transmission to 100 addresses as the maximum number is designated.

After that, the MFP 100 transmits a DATA command 911 which notifies that mail data is to be transmitted. After making preparations, the mail server 103 returns a response code 912 beginning with “354”.

When notified that the mail server 103 has prepared for data reception, the MFP 100 transmits, from 913 to 916, the electronic mail data explained with reference to FIG. 14 to the mail server 103.

When the whole electronic mail data is completely transmitted, “.” indicating the data end is transmitted in 917. The mail server 103 having received the data end code 917 transmits a response code 918 beginning with “250” and indicating “normal”, thereby notifying that the data is normally received.

Since the data transmission is normally processed, copy1.xyz.co.jp as the SMTP client transmits a QUIT command 919 to the mail server 103 to notify termination of the connection. Accordingly, the main server 103 transmits a response code 920 beginning with “221” and indicating “normal”, thereby terminating the SMTP connection.

Note that the number of addresses to which e-mail transmission can be performed at one time by using the SMTP is 100 in accordance with RFC2821, but the number is not necessarily limited to 100. The number of addresses to which transmission can be performed at once can be freely designated. Also, when division is to be performed in accordance with the designated number of addresses, these addresses can be freely grouped. For example, when addresses are grouped such that the domains match as well as possible, or the contents (e.g., the resolutions, the sizes, or the numbers of colors) of data to be transmitted match, the processing efficiency increases.

In addition, images to be transmitted are not limited to those scanned by the scanner. That is, the same effects can be obtained by FAX received images, IFAX received images, and images formed by the printer function.

Furthermore, the transmission image format is explained by using the TIFF. However, the same effects can be obtained by using image formats such as PDF (Portable Document Format), PS (PostScript), GIF (Graphics Interchange Format), PNG (Portable Network Graphics), and JPEG.

In this embodiment having the above arrangement, an electronic mail address field describing the mail addresses of all recipients and mail data formed by adding, to a read image, an image header which changes from one address to another are transmitted to each address. This allows each recipient to confirm to whom the mail has been broadcast. In addition, destination information which changes from one recipient to another can be added to, e.g., the header portion of the read image.

Also, in this embodiment, a mail address field describing the mail addresses of all recipients and mail formed by adding, to a read image, an image header which changes from one address to another are transmitted to a predetermined number of addresses. Consequently, electronic mail can be safely transmitted independently of the design of the mail server.

Furthermore, data other than image data may also be transmitted.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or script data supplied to an operating system.

Examples of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM, DVD-R or DVD-RW).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2004-211962 filed on Jul. 20, 2004, the entire contents of which are hereby incorporated by reference herein.

What is claimed is:

1. An image communication apparatus comprising:
image reading unit arranged to read an image and convert the read image into electronic data;
transmission address input unit capable of designating a plurality of destinations;
address field forming unit arranged to form an electronic mail address field describing all the addresses designated by said destination input unit;
image header adding unit arranged to add address information of at least one address to the image read by said image reading unit, thereby generating a synthesized image;
electronic mail data forming unit arranged to form electronic mail data on the basis of the electronic mail address field and the synthesized image obtained by said image header adding unit; and
transmitting unit arranged to transmit the electronic mail data formed by said electronic mail data forming unit to each destination.

2. The apparatus according to claim 1, further comprising unit arranged to determine whether to perform a resolution conversion process on the synthesized image, and, if it is determined that the resolution conversion process is necessary, perform the resolution conversion process, and then execute image compression.

3. The apparatus according to claim 1, wherein
said transmission address input unit comprises:
information of image processing capability of each destination; and
unit arranged to execute image processing on an image to be transmitted, in accordance with the image processing capability of each destination.

4. The apparatus according to claim 3, wherein the image processing capability includes a paper size, resolution, and compression scheme.

5. The apparatus according to claim 1, wherein said electronic mail data forming unit forms electronic mail such that a Message-Id of the mail changes from one mail to another.

6. The apparatus according to claim 1, wherein the destination is a transmission mode based on an assumption that mail is to be transmitted to an image communication apparatus of the same type.

7. An image communication apparatus comprising:
image reading unit arranged to read an image and convert the read image into electronic data;
transmission address input unit capable of designating a plurality of destinations;
address field forming unit arranged to form an electronic mail address field describing all the addresses designated by said destination input unit;
electronic mail data forming unit arranged to form electronic mail data on the basis of the electronic mail address field formed by said address field forming unit, and the image read by said image reading unit; and
transmitting unit arranged to transmit the electronic mail formed by said electronic mail data forming unit for each predetermined address unit a plurality of number of times.

8. The apparatus according to claim 7, wherein the electronic mail data formed by said electronic mail forming unit have the same Message-Id.

9. The apparatus according to claim 7, wherein the destination is a transmission mode based on an assumption that mail is to be transmitted to an electronic mail address of a personal computer.

10. An image communication method comprising:
an image reading step of reading an image and converting the read image into electronic data;
a transmission address input step capable of designating a plurality of destinations;
an address field formation step of forming an electronic mail address field describing all the addresses designated in the destination input step;
an image header addition step of adding address information of at least one address to the image read in the image reading step, thereby generating a synthesized image;
an electronic mail data formation step of forming electronic mail data on the basis of the electronic mail address field and the synthesized image obtained in the image header addition step; and
a transmission step of transmitting the electronic mail data formed in the electronic mail data formation step to each destination.

11. The method according to claim 10, further comprising an image compression step of determining whether to perform a resolution conversion process on the synthesized image, and, if it is determined that the resolution conversion process is necessary, performing the resolution conversion process, and then executing image compression.

12. The method according to claim 10, wherein
in the destination input step, information of image processing capability of each destination is input, and
the image communication method further comprises a step of executing image processing on an image to be transmitted, in accordance with the image processing capability of each destination.

13. The method according to claim 12, wherein the image processing capability includes a paper size, resolution, and compression scheme.

14. The method according to claim 10, wherein in the electronic mail data formation step, electronic mail is formed such that a Message-Id of the mail changes from one mail to another.

15. The method according to claim 10, wherein the destination is a transmission mode based on an assumption that mail is to be transmitted to an image communication apparatus of the same type.

16. An image communication method comprising:
an image reading step of reading an image and converting the read image into electronic data;
a transmission address input step capable of designating a plurality of destinations;
an address field formation step of forming an electronic mail address field describing all the addresses designated in the destination input step;
an electronic mail data formation step of forming electronic mail data on the basis of the electronic mail address field formed in the address field formation step, and the image read in the image reading step; and
a transmission step of transmitting the electronic mail formed in the electronic mail data formation step for each predetermined address unit a plurality of number of times.

17. The method according to claim 16, wherein the electronic mail data formed by said electronic mail forming unit have the same Message-Id.

18. The method according to claim 16, wherein the destination is a transmission mode based on an assumption that mail is to be transmitted to an electronic mail address of a personal computer.

19. A computer program for image communication, comprising program codes for executing:
an image reading step of reading an image and converting the read image into electronic data;
a transmission address input step capable of designating a plurality of destinations;
an address field formation step of forming an electronic mail address field describing all the addresses designated in the destination input step;
an image header addition step of adding address information of at least one address to the image read in the image reading step, thereby generating a synthesized image;
an electronic mail data formation step of forming electronic mail data on the basis of the electronic mail address field and the synthesized image obtained in the image header addition step; and
a transmission step of transmitting the electronic mail data formed in the electronic mail data formation step to each destination.

20. A computer program for image communication, comprising program codes for executing:
an image reading step of reading an image and converting the read image into electronic data;
a transmission address input step capable of designating a plurality of destinations;
an address field formation step of forming an electronic mail address field describing all the addresses designated in the destination input step;
an electronic mail data formation step of forming electronic mail data on the basis of the electronic mail address field formed in the address field formation step, and the image read in the image reading step; and
a transmission step of transmitting the electronic mail formed in the electronic mail data formation step for each predetermined address unit a plurality of number of times.

21. A computer-readable storage medium which stores a program cited in claim 19.

22. A computer-readable storage medium which stores a program cited in claim 20.
